(19) United States
(12) Patent Application Publication
(10) Pub. No.: US 2007/0103124 A1
(43) Pub. Date: May 10, 2007

(54) System and method for controlling the drive strength of output drivers in integrated circuit devices

(75) Inventor: John D. Heightley, Colorado Springs, CO (US)

Correspondence Address: HOGAN & HARTSON LLP, ONE TABOR CENTER, SUITE 1500, 1200 SEVENTEENTH ST, DENVER, CO, 80202, US

(73) Assignees: United Memories, Inc.; Sony Corporation

(21) Appl. No.: 11/267,660

(22) Filed: Nov. 4, 2005

(51) Int. Cl. G05F 1/10; G05F 1/00; H02J 3/12

(52) U.S. Cl. 323/234; 323/274; 323/284

(57) ABSTRACT

A system and method for controlling the drive strength of output drivers in integrated circuit devices employing, in a representative embodiment, a single reference voltage and a single comparator without the requirement of a dead-band. The technique of the present invention guarantees that the output voltage will always be within one least significant bit of drive strength of the target level that is set by the single reference voltage.

### BACKGROUND OF THE INVENTION

The present invention relates, in general, to the field of integrated circuit (IC) devices. More particularly, the present invention relates to a system and method for controlling the drive strength of output drivers in integrated circuit devices.

As the speed of DRAMs and processors has increased, it has become necessary to calibrate the drive strength of the device output drivers in order to maintain the fidelity of the output signals. Conventionally, the drive strength is adjusted by having binary weighted legs in the output drive transistors that can be selectively activated or deactivated based on the difference between the actual drive strength and the desired drive strength.

Measuring and adjusting the drive strength of the pull-up driver is done by connecting the output node through a known impedance to ground and selectively turning on the pull-up driver. The voltage on the output node is then compared to a reference voltage. If the output voltage is higher than the reference voltage, the strength of the output pull-up transistor is decreased by one least significant bit of drive strength. If the voltage is lower than the reference voltage, the drive strength of the output pull-up transistor is increased by one least significant bit of drive strength. This process continues until the drive strength falls within a specified range.

Measuring and adjusting the drive strength of the pull-down driver is done by connecting the output node through a known impedance to the output power supply voltage and selectively turning on the pull-down driver. The voltage on the output node is then compared to a reference voltage. If the output voltage is higher than the reference voltage, the drive strength of the output pull-down transistor is increased by one least significant bit of drive strength. If the voltage is lower than the reference voltage, the drive strength of the output pull-down transistor is decreased by one least significant bit of drive strength. This process continues until the drive strength falls within a specified range.

Typically, the comparison between the driven output node voltage and the reference voltage is accomplished using a differential amplifier. However, if a single differential amplifier and a single reference voltage are used, the calibration process will not converge and an “oscillating” condition results. For example, consider the case wherein the drive strength of the pull-up driver is increased in response to the output voltage being below the reference voltage. As the drive strength reaches the target level, the next adjustment will cause the output voltage to rise and cross the reference voltage. The next comparison will, in turn, cause the drive strength to be decreased by the same amount by which it was previously increased and the subsequent comparison will cause the drive strength to again be increased.

The way that such an oscillating situation is typically avoided is by having two different reference voltages separated by a “dead-band.” Two differential amplifiers are then used with one having the upper reference voltage as a first input and the output node as a second input and the second differential amplifier having the lower reference voltage as a first input and the output node as a second input. The target level for the output voltage is then set midway between the two reference voltages. By making the least significant bit adjustment cause a change in voltage that is less than the magnitude of the dead-band, the calibration process will stop once an adjustment causes the output voltage to fall within the dead-band. This is true because neither differential amplifier will indicate that an increase or decrease in drive strength is required when the output voltage is within the dead-band. As long as the output voltage is between the two reference levels, the adjustment stops. The accuracy of the adjustment relative to the target level is determined by the magnitude of the dead-band required to account for the sum of the offsets of the two differential amplifiers and the sum of the tolerances of the two reference voltages.

### SUMMARY OF THE INVENTION

Rather than try to eliminate the oscillations that result from the use of a single reference voltage and a single comparator by the use of the traditional two reference voltages separated by a dead-band and two comparators, the system and method of the present invention allows the oscillations to occur and gives an indication that no further adjustments are required once the oscillating condition occurs. A single reference voltage and a single comparator can, therefore, be used and no dead-band is required. The technique of the present invention then assures that the output voltage will always be within one least significant bit of drive strength of the target level that is set by the single reference voltage. The approach is more accurate than the conventional techniques because it only has the inherent uncertainty of one comparator and one reference voltage.

To implement the system and method of the present invention, each checking cycle begins with two successive comparisons. After the first comparison, the appropriate adjustment in drive strength is made. After the second comparison is made, an Exclusive OR (XOR) circuit is used to determine whether the results of the two successive comparisons are opposite, i.e., an indication to increase (or decrease) the drive strength followed by an indication to decrease (or increase) the drive strength. If the successive comparisons are opposite, the checking is terminated. If the successive comparisons are not opposite, the adjustment called for by the second comparison is made and a third comparison is initiated. This process continues until two successive comparisons are determined to be opposite and the process terminates.

Particularly disclosed herein is a system and method for controlling an integrated circuit device driver which comprises: providing a reference voltage; comparing an output voltage of the driver driving a known load impedance with the reference voltage; determining whether the output voltage is at a greater or lesser relative level with respect to the reference voltage; adjusting the drive strength of the driver so that the output voltage moves toward the reference voltage; and repeating the operations of comparing and determining on the adjusted output voltage until two successive determining operations indicate respectively opposite relative levels of the adjusted output voltage with respect to the reference voltage. In a more particular implementation, the system and method of the present invention further comprises: further adjusting the adjusted output voltage of the driver toward the reference voltage if two successive determining operations respectively indicate a same relative level of the adjusted output voltage with respect to the reference voltage; and repeating the operations of comparing and determining on the adjusted output voltage.

Also particularly disclosed herein is a system and method for adjusting the output voltage level of a device driver comprising: determining if the output voltage level is greater or lesser than a reference voltage level; adjusting the output voltage level toward the reference voltage level; and repeating the operation of determining until two successive such operations indicate that the output voltage level is now lesser than the reference voltage level if previously greater, or now greater than the reference voltage level if previously lesser. In a more particular implementation, the system and method of the present invention further comprises: further adjusting the output voltage level toward the reference voltage level if the two successive such operations indicate that the output voltage level is still lesser than the reference voltage level if previously lesser or still greater than the reference voltage level if previously greater; and repeating the operation of determining on the adjusted output voltage level.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is an illustrative functional block diagram of a system showing how a representative embodiment of the present invention might relate to an Application IC and a dynamic random access memory (DRAM) that has adjustable output drive;

FIGS. 2A and 2B together are a schematic illustration of a representative embodiment of the present invention implemented in conjunction with a single reference voltage and comparator without the requirement of a dead-band and wherein the drive strength checks of the pull-up and pull-down drivers are initiated by the signals DRIVE1 and DRIVE0 going “high” respectively;

FIG. 3 is a more detailed, schematic illustration of a representative embodiment of the DRAMSAM circuit block of the preceding figures;

FIG. 4 is a more detailed, schematic illustration of a representative embodiment of the COMPARE circuit block of FIG. 2A; and

FIGS. 5A and 5B are functional simulations of the operation of the representative embodiment of the present invention of FIGS. 2A and 2B for pull-up and pull-down checks respectively.

### DESCRIPTION OF A REPRESENTATIVE EMBODIMENT

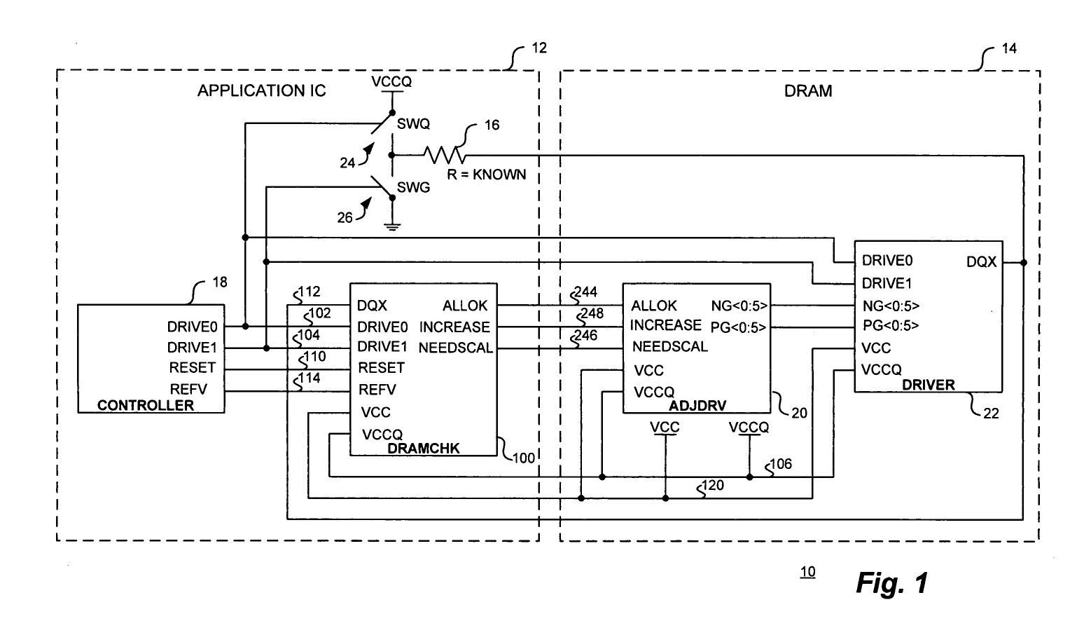

With reference now to FIG. 1, an illustrative functional block diagram of a system 10 is shown illustrating how a representative embodiment of the present invention might relate to an application IC 12 and a dynamic random access memory (DRAM) 14 that has adjustable output drive. VCC and VCCQ are logic and driver power supply voltages on lines 120 and 106 respectively and provide inputs to the various circuit blocks as shown.

The illustrative output driver block 22 (DRIVER) has its pull-up drive strength adjusted through the drive strength control signals PG<0:5> while its pull-down drive strength is adjusted through the drive strength control signals NG<0:5>. Since six control bits are provided, the drivers have 64 possible drive strengths. The illustrative drive adjustment control block 20 (ADJDRV) receives signals ALLOK, INCREASE, and NEEDSCAL inputs (on lines 244, 248 and 246 respectively) from the drive strength check block 100 (DRAMCHK, which will be more fully described hereinafter with respect to the succeeding figures) and has outputs NG<0:5> and PG<0:5>.

With particular reference to the outputs of the DRAMCHK circuit 100, if ALLOK on line 244 goes “high”, the drive adjustment control block 20 will cause no change in drive strength signals PG<0:5> or NG<0:5>. If NEEDSCAL on line 246 goes “high”, the drive strength control signals will be increased or decreased by one least significant bit by the drive adjustment control block 20 depending on whether the signal INCREASE on line 248 is “high” or “low” respectively. The illustrative controller block 18 (CONTROLLER), has outputs DRIVE0 on line 102, DRIVE1 on line 104, RESET on line 110, and REFV on line 114, which are provided as inputs to the DRAMCHK circuit 100.

The circuit 100 receives the output of the controller block 18 as its inputs in addition to the signal DQX on line 22. The signal DQX is created at the junction of the output of the driver 22 and a known load resistor 16 (R). For purposes of illustration, switches SWQ 24 and SWG 26 are shown for enabling the connection of the other terminal of the resistor 16 to the driver supply on line 106 (VCCQ) or ground respectively.

To effectuate a drive strength check, the controller 18 will cause either DRIVE1 on line 104 or DRIVE0 on line 102 to go “high” selectively connecting resistor 16 to ground or VCCQ, turning on the pull-up or pull-down driver in the driver 22 and initiating either a pull-up or pull-down drive strength check by the DRAMCHK circuit 100, all respectively. The voltage level on DQX line 112 is compared to the reference voltage REFV on line 114 and either the signal ALLOK (line 244) will go “high” or the signal NEEDSCAL (line 246) will go “high” depending on whether the drive strength is within the specified range or needs to be changed. If NEEDSCAL on line 246 goes “high”, the state of the signal INCREASE on line 248 will determine the direction of the drive strength change and the drive adjustment control block 20 will make the appropriate change in the drive strength control signals PG<0:5> or NG<0:5>.

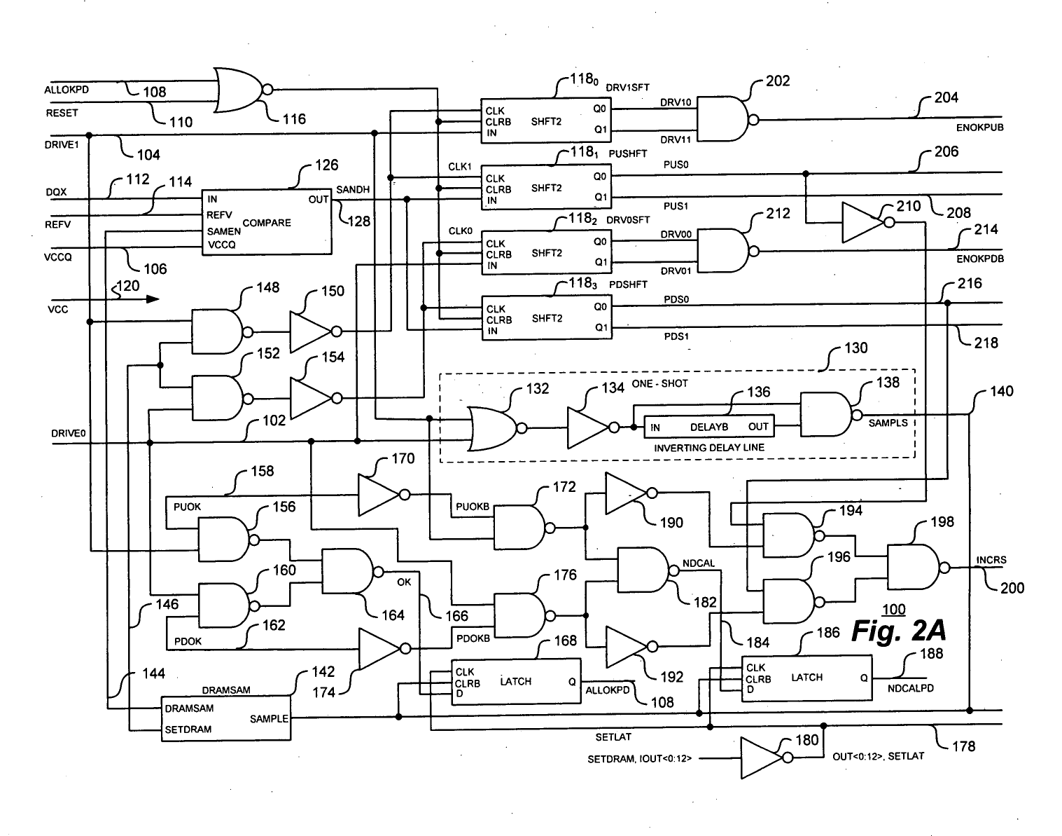

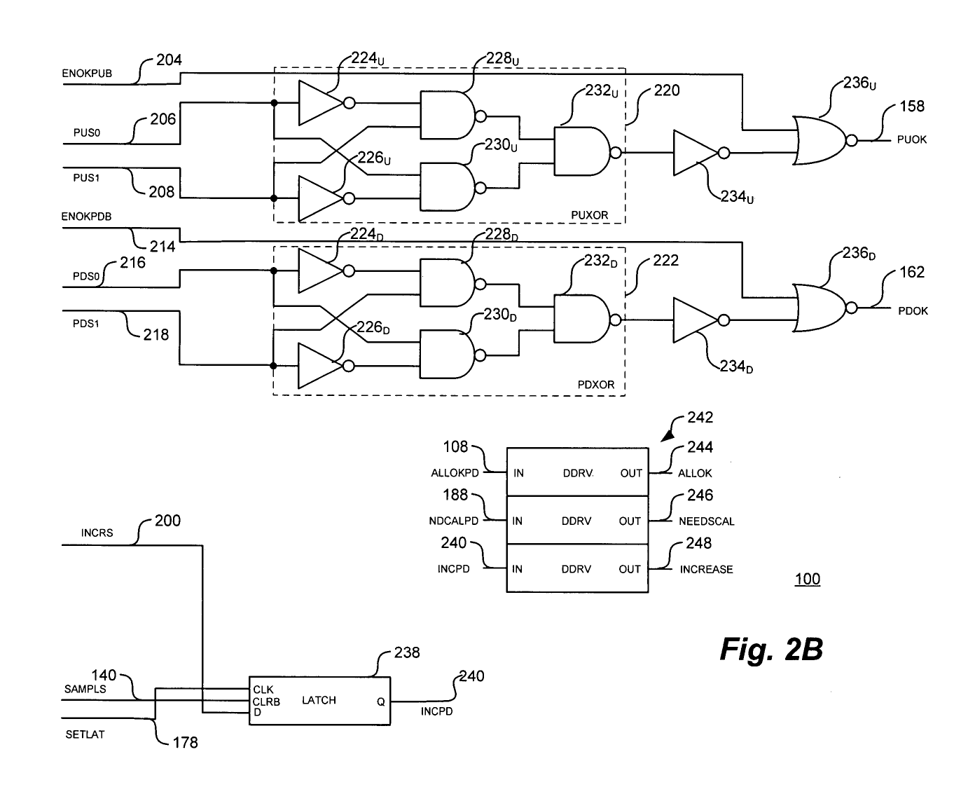

With reference additionally now to FIGS. 2A and 2B, a schematic illustration of a representative DRAMCHK circuit 100 embodiment of the present invention is shown. As will be seen, the circuit 100 is implemented in conjunction with a single reference voltage (REFV) and comparator without the requirement of a dead-band and wherein the drive strength checks of the pull-up and pull-down drivers are initiated by the signals DRIVE1 on line (or node) 104 or DRIVE0 on line 102 going “high” respectively. It should be noted that all circuitry of the circuit 100, with the exception of portions of the compare circuit block 126 as will be described more fully hereinafter, are coupled to a global logic power supply level of VCC.

In addition to the logic power supply voltage VCC and the output driver power supply input VCCQ, the circuit 100 receives the inputs RESET, DQX and REFV on lines 110, 112 and 114 respectively. The internally generated signal ALLOKPD on line 108 and the RESET signal on line 110 provide inputs to NOR gate 116 which has its output coupled to the clear bar (CLRB) inputs of a series of shift registers 118₀ through 118₃. Line 112 is externally connected to the junction between the driver to be calibrated and the known impedance that is driven by the driver during the checking cycle.

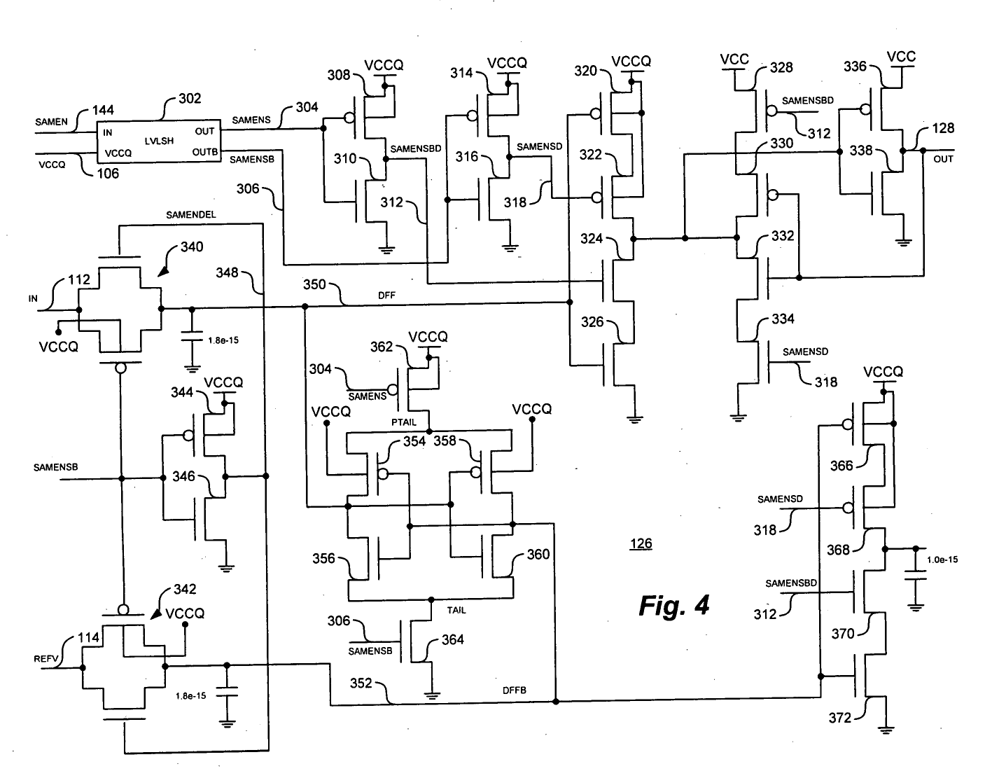

A compare circuit block 126, the details of which will be more fully described hereinafter with respect to FIG. 4, has its “IN” input coupled to line 112, its REFV input coupled to line 114, its VCCQ input coupled to line 106 and its SAMEN input coupled to receive the DRAMSAM signal on line 144. The compare circuit block 126 produces a SANDH signal at its output on line 128 which is provided to the “IN” terminals of the shift registers 118₁ and 118₃. The “IN” terminals of shift registers 118₀ and 118₂ are coupled to receive the DRIVE1 signal on line 104 and the DRIVE0 signal on line 102 respectively.

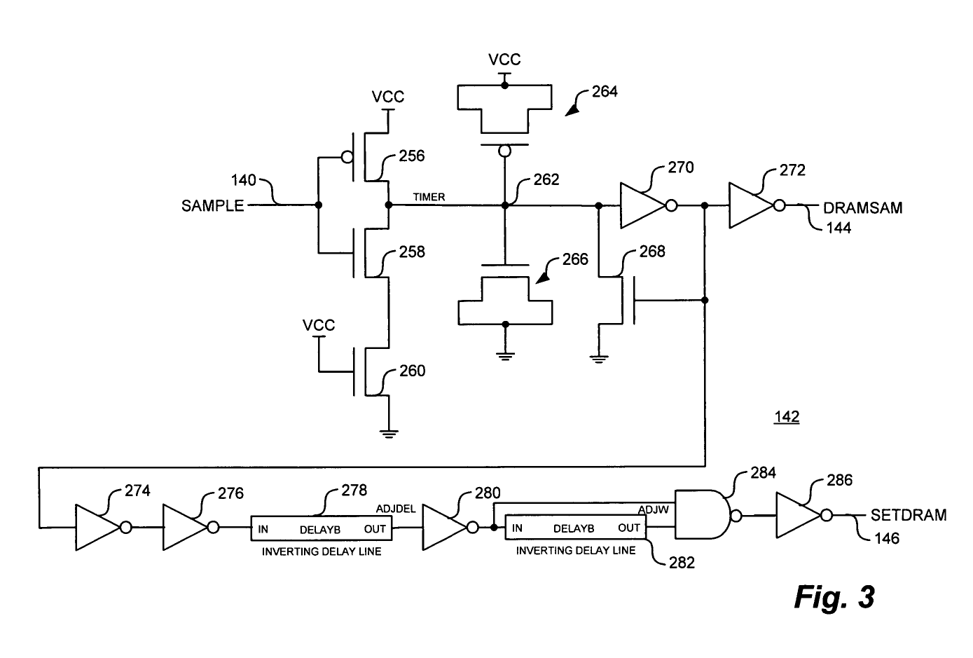

The circuit 100 further comprises a one-shot 130 which includes an input NOR gate 132 which is also coupled to receive the DRIVE1 signal on line 104 and the DRIVE0 signal on line 102. Output of the NOR gate 132 is inverted through inverter 134 for input to an inverting delay line 136. Output of the inverting delay line 136 and the inverter 134 is supplied as inputs to NAND gate 138 to provide a SAMPLS signal on line 140. The SAMPLS signal on line 140 is provided as an input to DRAMSAM circuit block 142 which will be described in greater detail with respect to FIG. 3 and to latches 168, 186 and 238 (FIG. 2B). As previously mentioned, the DRAMSAM circuit block 142 provides a DRAMSAM output on line 144 as well as a SETDRAM output on line 146.

The SETDRAM signal on line 146 is provided as one input to a two-input NAND gate 148 which has its other input coupled to line 104 to receive the DRIVE1 signal. Output of the NAND gate 148 is inverted through inverter 150 to provide a CLK1 signal to the CLK inputs of the shift registers 118₀ and 118₁. In like manner, the SETDRAM signal on line 146 is provided as one input to another two-input NAND gate 152 which has its other input coupled to line 102 to receive the DRIVE0 signal. Output of the NAND gate 152 is similarly inverted through inverter 154 to provide a CLK0 signal to the CLK inputs of the shift registers 118₂ and 118₃.

A two-input NAND gate 156 has one input coupled to line 104 and another coupled to receive a PUOK signal on line 158 (See FIG. 2B in particular). Another two-input NAND gate 160 has one input coupled to line 102 and another coupled to receive a PDOK signal on line 162 (See FIG. 2B also). The outputs of the NAND gates 156 and 160 are provided as inputs to a NAND gate 164 to provide an OK signal on line 166 for input to the “D” input of a latch 168. The PUOK signal on line 158 is inverted through inverter 170 to provide a PUOKB signal as an input to two-input NAND gate 172 which has its other input coupled to line 104. Similarly, the PDOK signal on line 162 is inverted through inverter 174 to provide an input PDOKB to one input of two-input NAND gate 176 which has its other input coupled to line 102. The CLK inputs of latches 168, 186 and 238 (FIG. 2B) are coupled to receive a SETLAT signal on line 178 at the output of a string of thirteen inverters 180 which has its input coupled to receive the SETDRAM signal on line 146.

A two-input NAND gate 182 has its inputs coupled to the outputs of NAND gates 172 and 176 and provides an NDCAL signal on line 184 for input to the “D” input of latch 186. The latch 186 produces an NDCALPD signal on line 188 while the latch 168 provides the ALLOKPD signal on line 108. The output of the NAND gate 172 is also inverted through inverter 190 to provide one input to a two-input NAND gate 194 which has its output coupled to one input of another two-input NAND gate 198. Likewise, the output of the NAND gate 176 is also inverted through inverter 192 to provide one input to a two-input NAND gate 196 which has its output coupled to the other input of NAND gate 198. The signal INCRS on line 200 is taken at the output of NAND gate 198.

The Q0 and Q1 outputs of DRV1SFT shift register 118₀ respectively provide the DRV10 and DRV11 inputs to two-input NAND gate 202 which provides an ENOKPUB signal on line 204. The Q0 and Q1 outputs of PUSHFT shift register 118₁ respectively provide the PUS0 and PUS1 signals on lines 206 and 208. The PUS0 signal on line 206 is inverted through inverter 210 to provide the remaining input to NAND gate 194. The Q0 and Q1 outputs of DRV0SFT shift register 118₂ respectively provide the DRV010 and DRV01 inputs to two-input NAND gate 212 which provides an ENOKPDB signal on line 214. The Q0 and Q1 outputs of PDSHFT shift register 118₃ respectively provide the PDS0 and PDS1 signals on lines 216 and 218. The PDS0 signal on line 216 is provided to the remaining input to NAND gate 196.

With particular reference to FIG. 2B, the circuit 100 further comprises a pair of exclusive OR (XOR) logic blocks 220 (PUXOR) and 222 (PDXOR). The logic block 220 is coupled to lines 206 and 208 to receive the PUS0 and PUS1 signals respectively. The PUS0 signal is inverted by means of inverter 224_{U} while the PUS1 signal is inverted through inverter 226_{U}. The output of inverter 224_{U} is coupled to one input of two-input NAND gate 228_{U} which has the PUS1 signal on line 208 coupled to the other input. Similarly, the output of inverter 226_{U} is coupled to one input of two-input NAND gate 230_{U} which has the PUS0 signal on line 206 coupled to the other input. The outputs of the NAND gates 228_{U} and 230_{U} are provided as inputs to a two-input NAND gate 232_{U} which has its output coupled to the input of an inverter 234_{U}. Output of the inverter 234_{U} is coupled to one input of two-input NOR gate 236_{U} which has its other input coupled to receive the ENOKPUB signal on line 204. The output of the NOR gate 236_{U} produces the PUOK signal on line 158 as previously described.

In like manner, the logic block 222 is coupled to lines 206 and 208 to receive the PDS0 and PDS1 signals respectively. The PDS0 signal is inverted by means of inverter 224_{D} while the PDS1 signal is inverted through inverter 226_{D}. The output of inverter 224_{D} is coupled to one input of two-input NAND gate 228_{D} which has the PDS1 signal on line 218 coupled to the other input. Similarly, the output of inverter 226_{D} is coupled to one input of two-input NAND gate 230_{D} which has the PDS0 signal on line 216 coupled to the other input. The outputs of the NAND gates 228_{D} and 230_{D} are provided as inputs to a two-input NAND gate 232_{D} which has its output coupled to the input of an inverter 234_{D}. Output of the inverter 234_{D} is coupled to one input of two-input NOR gate 236_{D} which has its other input coupled to receive the ENOKPDB signal on line 214. The output of the NOR gate 236_{D} produces the PDOK signal on line 162 as previously described.

Also illustrated is latch 238 which receives the INCRS signal on line 200 at its “D” input, the SAMPLS signal on line 140 at its CLRB input and the SETLAT signal on line 178 at its CLK input. The Q output of the latch 238 provides the INCPD signal. Outputs of the latches 168, 186 (FIG. 2A) and 238 are provided to a number of buffers 242 to produce an ALLOK signal on line 244, an NEEDSCAL signal on line 246 and an INCREASE signal on line 248 respectively as will be more fully described hereinafter.

In operation, the circuit 100 comprises an implementation of the “oscillating method” of the present invention described previously. The circuit 100 is initially reset by the input “RESET” on line 110. A drive strength check of the pull-up driver is initiated by connecting a known impedance from ground to input DQX on line 112, turning “on” the pull-up driver and by the DRIVE1 signal on line 104 going “high”. A drive strength check of the pull-down drive is initiated by connecting a known impedance from VCCQ to input DQX on line 112, turning “on” the pull-down driver and by the DRIVE0 signal on line 102 going “high”. DRIVE1 and DRIVE0 never go “high” at the same time.

When either the DRIVE1 or DRIVE0 signal goes “high”, the ONE-SHOT circuit 130 generates a negative pulse on SAMPLS line 140. The pulse causes a positive signal to be generated on node (or line) 144 by the DRAMSAM circuit block 142. The positive signal on node 144 enables the compare circuit block 126 which compares the level on the driven node DQX 112 with the reference signal on node REFV 114. The duration of the positive signal on node DRAMSAM 144 is long enough to allow the compare circuit block 126 to settle and make an accurate comparison. When the DRAMSAM signal on line 144 goes “low”, the result of the comparison is latched in the compare circuit block 126 and output on SANDH node 128.

In addition, after the DRAMSAM signal on line 144 goes “low”, a delayed positive pulse is generated on node SETDRAM 146 that causes the state of the signal SANDH to be shifted into either the two stage shift register (“shft2”) PUSHFT 118₁ or shift register PDSHFT 118₃ depending on whether the signal DRIVE1 or DRIVE0 is “high”. The pulse on SETDRAM line 146 also causes the state of DRIVE1 to be shifted into the two stage shift register DRV1SFT 118₀ or the state of DRIVE0 to be shifted into shift register DRV0SFT 118₂ depending on whether DRIVE1 or DRIVE0 is “high” respectively.

The four two-bit shift registers 118₀-118₃ are cleared on the assertion of the RESET signal and every time the checking is terminated as indicated by the signal ALLOKPD on line 108 going “high”. The two 2-bit shift registers DRV1SFT 118₀ and DRV0SFT 118₂ register the DRIVE1 and DRIVE0 positive transitions respectively as described previously. Until two transitions have occurred on either DRIVE1 line 104 or DRIVE0 line 102 after the shift registers have been cleared, i.e., two drive strength adjust cycles have been initiated, the XOR comparison cannot give an OK indication because the signals on nodes PUOK 158 and PDOK 162 are held “low” by the signals on nodes ENOKPUB 204 and ENOKPDB 214 respectively. The other two 2-bit shift registers PUSHFT 118₁ and PDSHFT 118₃ store the results of two successive comparisons that appear on node 128 (SANDH) and provide the inputs to the two XOR circuits 220 and 222. The outputs of the XOR circuits 220 and 222 are used to generate a high signal at node OK 166 or node NDCAL 184 depending on whether the last two successive comparisons resulted in opposite indications or identical indications respectively.

The state of the bit Q0 of the shift registers PUSHFT and PDSHFT are used to determine whether the signal INCRS on line 200 is “high” or “low” depending on whether the drive needs to be increased or decreased respectively. No actual adjustment will occur unless the signal NDCAL on node 184 is “high” however. The signals OK, NDCAL, and INCRS are latched at the end of each check cycle by a further delayed version of the pulse on node SETDRAM 146 that occurs on node SETLAT 178. The output of the latches are buffered by buffers 242 and provide output signals ALLOK, NEEDSCAL, and INCREASE. When the signal ALLOKPD occurs, the shift registers 118₀ through 118₃ are reset by the output of the NOR gate 116 in preparation for the next checking cycle. The three latches 168, 186 and 238 are cleared at the beginning of each drive check cycle by the pulse on node SAMPLS 140.

With reference additionally now to FIG. 3, a more detailed, schematic illustration of a representative embodiment of the DRAMSAM circuit block 142 of the preceding figures is shown. The representative embodiment of the DRAMSAM circuit block 142 comprises series coupled P-channel transistor 256 and N-channel transistors 258 and 260 coupled between a supply voltage source and circuit ground. The gate terminals of transistors 256 and 258 are coupled together to form the SAMPLE input 140 and their common coupled drain terminals define a TIMER node 262. The gate of transistor 260 is coupled to the supply voltage source. A capacitor coupled P-channel transistor 264 couples node 262 to the supply voltage line while a capacitor coupled N-channel transistor 266 couples it to circuit ground. Node 262 is also coupled to the input of an inverter 270 as well as the drain terminal of an N-channel transistor 268 which has its source coupled to circuit ground and its gate terminal coupled to the output of the inverter 270. Another inverter 272 in series with inverter 270 provides the DRAMSAM signal on line 144.

The output of inverter 270 is also coupled through series connected inverters 274 and 276 to the input of a first inverting delay line 278 which produces an ADJDEL signal at its output. The output of the inverting delay line 278 is further coupled through and inverter 280 to the input of a second inverting delay line 282. The output of the second inverting delay line 282 produces a signal ADJW which, together with the output of the inverter 280, provide the inputs to a two-input NAND gate 284. The output of the NAND gate 284 is inverted through inverter 286 to provide the SETDRAM signal on node 146.

In the quiescent state, the input SAMPLE 140 is held “high” causing the TIMER node 262 to be “low” and the output DRAMSAM on node 144 to be “low”. The inverting delay lines “DELAYB” 278 and 282 provide a delayed and inverted version of their inputs so that in the quiescent state of input SAMPLE, SETDRAM on line 146 is also “low’.

As previously described, at the beginning of a drive check cycle, either signal DRIVE1 or DRIVE0 will go “high” causing the SAMPLE line 140 to go “low” for a short time via the signal SAMPLS. This negative pulse will drive the TIMER node 262 “high” and output DRAMSAM on line 144 will go “high”. After the SAMPLE signal returns to a “high” state, the TIMER node 262 will begin to discharge at a rate determined by the capacitance on the node and the current through transistor 260. When the node reaches the threshold of the inverter 270 (with the signal TIMER as its input), the DRAMSAM signal will go “low”. The duration of the “high” time of the DRAMSAM signal on line 144 is set so as to allow sufficient time for the compare circuit block 126 to stabilize. The output of inverting delay line circuit 282 (ADJW) will go “high” after the other input to the NAND gate 284 goes “low” when the DRAMSAM signal on node 144 goes “high”. Thus, the SETDRAM signal on node 146 will remain “low”. When the DRAMSAM signal goes “low”, the SETDRAM signal on line 146 will go “high” after a delay set by the delay through the inverting delay line circuit 278 (ADJDEL). The duration of the “high” time of the SETDRAM signal is set by the delay through the inverting delay line circuit 282. As previously described, the pulse on SETDRAM node 146 is used to shift data into the shift registers 118₀ through 118₃ and is further delayed to create the signal SETLAT on node 178 to set latches 168, 186 and 238.

With reference additionally now to FIG. 4, a more detailed, schematic illustration of a representative embodiment of the COMPARE circuit block 126 of FIG. 2A is shown. The compare circuit block 126 comprises a level shift circuit 302 which receives as inputs the SAMEN signal on line 144 and the VCCQ voltage level on node 106. The SAMEN signal swings between the logic power supply level VCC and ground. The level shift circuit 302 provides complementary outputs OUT and OUTB on nodes 304 (SAMENS) and 306 (SAMENSB) respectively. The signals SAMENS and SAMENSB swing between the output driver power supply level, VCCQ, and ground. This level shifting is required because, in general, signal IN on line 112 can be higher than the logic power supply level and the transmission gates 340 and 342 will not function properly unless signals SAMENDEL and SAMENSB swing between VCCQ and ground.

Node 304 is coupled to the input of an inverter comprising series coupled P-channel transistor 308 and N-channel transistor 310 coupled between VCCQ and circuit ground. Its output provides the signal SAMENSBD on line 312. Similarly, the node 306 is coupled to the input of another inverter comprising series coupled P-channel transistor 314 and N-channel transistor 316 coupled between VCCQ and circuit ground. Its output provides the signal SAMENSD on line 318.

Series coupled P-channel transistors 320, 322 together with series coupled N-channel transistors 324, 326 are coupled between VCCQ and circuit ground as shown. Node 312 is coupled to the gate of transistor 324 while node 318 is coupled to the gate of transistor 322. The gate terminals of transistors 320 and 326 are coupled together at node 350 as will be described in more detail hereinafter. An output node intermediate transistors 322 and 324 is coupled to an output node of a string of series coupled P-channel transistors 328, 330 and N-channel transistors 332, 334 coupled between VCC and circuit ground. This same output node is coupled to the gate of another inverter comprising series coupled P-channel transistor 336 and N-channel transistor 338 also coupled between VCC and circuit ground. Output of this inverter at node 128 provides an OUT signal. Also as shown, the gate of transistor 328 is coupled node 312 while the gate terminal of transistor 334 is coupled to node 318.

The IN terminal of the compare circuit block 126 for receiving the DQX signal on line 112 is applied to a first CMOS pass (or transmission) gate 340 for selective coupling to node 350. Similarly, the REFV input terminal of the compare circuit block 126 on line 114 is coupled through another CMOS pass gate 342 for selective coupling to node 352. The gate terminals of P-channel devices of the pass gates 340, 342 are coupled together to signal SAMENSB at the input of an inverter comprising series coupled P-channel transistor 344 and N-channel transistor 346 coupled between VCCQ and circuit ground. The output of this inverter is coupled to the gate terminals of the N-channel devices of the pass gates 340, 342.

A latch circuit including a pair of cross-coupled inverters comprising P-channel transistor 354 with N-channel transistor 356 and P-channel transistor 358 with N-channel transistor 360 are coupled between nodes PTAIL and TAIL. The latch circuit is coupled between nodes 350 and 352 as shown. A P-channel transistor 362 couples node PTAIL to VCCQ and has its gate terminal coupled to line 304. In like manner, an N-channel transistor 364 couples the node TAIL to circuit ground and has its gate terminal coupled to node 306. Series coupled P-channel transistors 366, 368 and N-channel transistors 370, 372 are coupled between VCCQ and circuit ground and are included to balance loading and coupling. Node 352 is coupled to the gate terminals of transistors 366 and 372 while the gate terminals of transistors 368 and 370 are respectively coupled to nodes 318 and 312.

What is essentially a “gated flip-flop” is employed as the representative embodiment of the compare circuit block 126 because it requires less power and is more sensitive than a standard differential amplifier. The input signal SAMEN on node 144 is level shifted by the level shifter circuit 302 (LVLSH) and when SAMEN goes “high”, the differential inputs are connected to the nodes 350 (DFF) and 352 (DFFB) of the latch through the transmission gates 340, 342. After sufficient settling time, the nodes 350 and 352 are at the same potential as the differential inputs. The previous state of the flip-flop is also latched at the output at node 128 when SAMEN goes “high’. The signal SAMEN on node 144 subsequently goes “low’ causing nodes 350 (DFF) and 352 (DFFB) to be isolated from the inputs and the flip-flop latches in the state determined by the differential voltage between these two nodes. The new state of the flip-flop is then passed to the output node 128 when the SAMEN signal goes “low”.

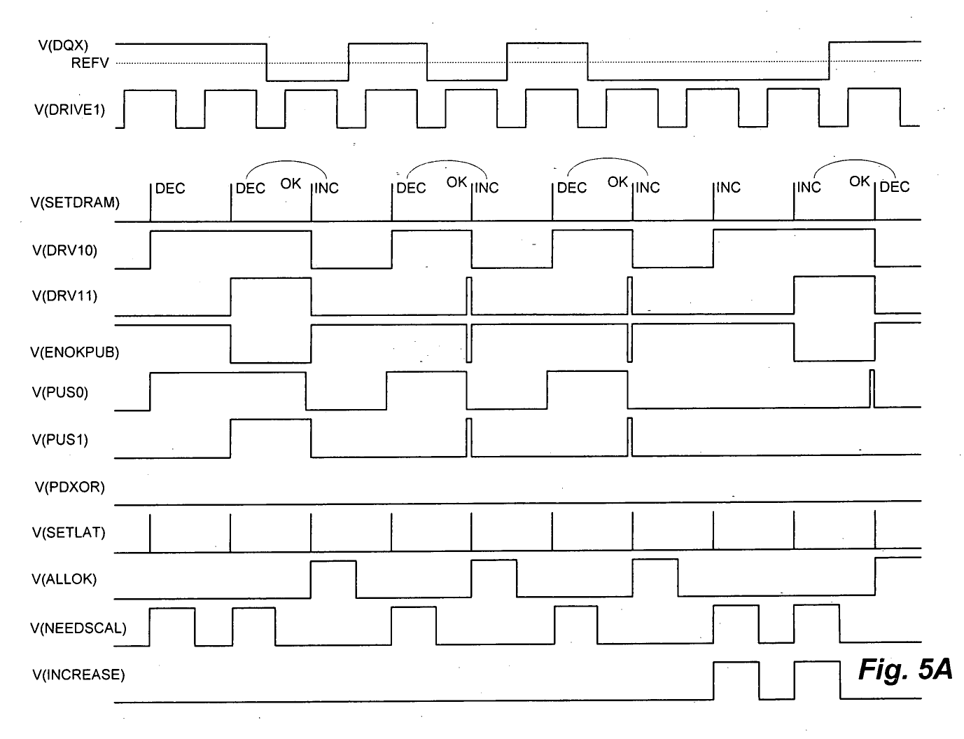

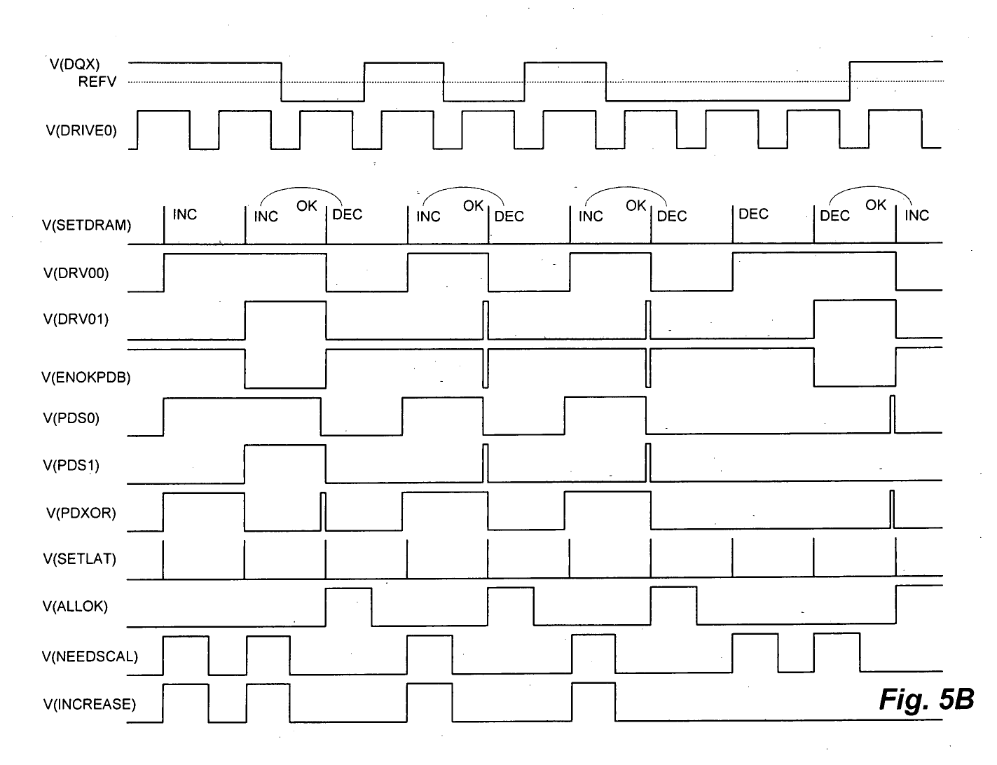

With reference additionally to FIGS. 5A and 5B, functional simulations of the operation of the representative embodiment of the present invention in the form of circuit 100 of FIGS. 2A and 2B are shown for pull-up and pull-down checks respectively. In these figures, two simulations are illustrated that demonstrate the operation of the circuit 100, one for a pull-up check (DRIVE1) and one for a pull-down check (DRIVE0). The uppermost line of the simulations shows the level on DQX line 112 which has excursions above and below the reference voltage which, in a representative embodiment, may be set at 0.9 volts. The fourth line down illustrates the occurrence of the pulse SETDRAM on line 146 that occurs at the end of each drive strength check. The decision that is made by the compare circuit block 126 is marked on the simulation for each drive strength check. The cases where an OK indication should be given because sequential decisions are opposite (and at least two drive strength checks have been initiated since the last OK indication) are marked with an OK on the simulation. Note that the only time an indication of INCREASE or DECREASE is meaningful is if NEEDSCAL is “high”. An indication of DECREASE is indicated when NEEDSCAL is “high” and INCREASE is “low”. Since the level on DQX is the same for the DRIVE1 and DRIVE0 simulations, the INCREASE/DECREASE indications are exactly the opposite for the two cases as is required.

While there have been described above the principles of the present invention in conjunction with specific circuit implementations, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

As used herein, the terms “comprises”, “comprising”, or any other variation thereof, are intended to cover a non-exclusive inclusion, such that a process, method, article, or apparatus that comprises a recitation of certain elements does not necessarily include only those elements but may include other elements not expressly recited or inherent to such process, method, article or apparatus. None of the description in the present application should be read as implying that any particular element, step, or function is an essential element which must be included in the claim scope and THE SCOPE OF THE PATENTED SUBJECT MATTER IS DEFINED ONLY BY THE CLAIMS AS ALLOWED. Moreover, none of the appended claims are intended to invoke paragraph six of 35 U.S.C. Sect. 112 unless the exact phrase “means for” is employed and is followed by a participle.

What is claimed is:

1. A method for controlling an integrated circuit device driver comprising:
providing a reference voltage;
comparing an output voltage of said driver driving a known load impedance with said reference voltage;
determining whether said output voltage is at a greater or lesser relative level with respect to said reference voltage;
adjusting said output voltage of said driver toward said reference voltage; and
repeating said operations of comparing and determining with said adjusted output voltage until two successive determining operations indicate respectively opposite relative levels of said adjusted output voltage with respect to said reference voltage.

2. The method of claim 1 further comprising:
further adjusting said adjusted output voltage of said driver toward said reference voltage if two successive determining operations respectively indicate a same relative level of said adjusted output voltage with respect to said reference voltage; and
repeating said operations of comparing and determining on said adjusted output voltage.

3. The method of claim 1 wherein said reference voltage is a single reference voltage for said integrated circuit device driver.

4. The method of claim 1 wherein said comparing is carried out by a single integrated circuit comparison block.

5. The method of claim 1 wherein said output voltage has substantially no dead-band.

6. A system for controlling an integrated circuit device driver comprising:
means for providing a reference voltage;
means for comparing an output voltage of said driver driving a known load impedance with said reference voltage;
means for determining whether said output voltage is at a greater or lesser relative level with respect to said reference voltage;
means for adjusting said output voltage of said driver toward said reference voltage; and
means for repeating said operations of comparing and determining with said adjusted output voltage until two successive determining operations indicate respectively opposite relative levels of said adjusted output voltage with respect to said reference voltage.

7. The system of claim 6 further comprising:
means for further adjusting said adjusted output voltage of said driver toward said reference voltage if two successive determining operations respectively indicate a same relative level of said adjusted output voltage with respect to said reference voltage; and
means for repeating said operations of comparing and determining on said adjusted output voltage.

8. The system of claim 6 wherein said reference voltage is a single reference voltage for said integrated circuit device driver.

9. The system of claim 6 wherein said means for comparing is carried out by a single integrated circuit comparison block.

10. The system of claim 6 wherein said output voltage has substantially no dead-band.

11. A method for adjusting the output voltage level of a device driver driving a known load impedance comprising:
determining if said output voltage level is greater or lesser than a reference voltage level;
adjusting said output voltage level toward said reference voltage level; and
repeating said operation of determining until two successive such operations indicate that said output voltage level is now lesser than said reference voltage level if previously greater, or now greater than said reference voltage level if previously lesser.

12. The method of claim 11 further comprising:
further adjusting said output voltage level toward said reference voltage level if said two successive such operations indicate that said output voltage level is still lesser than said reference voltage level if previously lesser or still greater than said reference voltage level if previously greater; and
repeating said operation of determining on said adjusted output voltage level.

13. The method of claim 11 wherein said reference voltage level is a single reference voltage level for said device driver.

14. The method of claim 11 wherein said operation of determining is carried out by a single integrated circuit comparison block.

15. The method of claim 11 wherein said output voltage level has substantially no dead-band.

16. A system for adjusting the output voltage level of a device driver driving a known load impedance comprising:
means for determining if said output voltage level is greater or lesser than a reference voltage level;
means for adjusting said output voltage level toward said reference voltage level; and
means for repeating said operation of determining until two successive such operations indicate that said output voltage level is now lesser than said reference voltage level if previously greater, or now greater than said reference voltage level if previously lesser.

17. The system of claim 16 further comprising:
means for further adjusting said output voltage level toward said reference voltage level if said two successive such operations indicate that said output voltage level is still lesser than said reference voltage level if previously lesser or still greater than said reference voltage level if previously greater; and
means for repeating said operation of determining on said adjusted output voltage level.

18. The system of claim 16 wherein said reference voltage level is a single reference voltage level for said device driver.

19. The system of claim 16 wherein said means for determining is carried out by a single integrated circuit comparison block.

20. The system of claim 16 wherein said output voltage level has substantially no dead-band.
